(19) United States
(12) Patent Application Publication
(10) Pub. No.: US 2014/0375646 A1
(43) Pub. Date: Dec. 25, 2014

(54) DYNAMIC ALTERATION OF GUIDES BASED ON RESOLUTION CHANGES

(71) Applicant: Microsoft Corporation, Redmond, WA (US)

(72) Inventors: Dante Gagne, BOTHELL, WA (US); Rodrigo Hermann, Seattle, WA (US); Yi Lin, ISSAQUAH, WA (US); Christian Schormann, Seattle, WA (US); Wei Li, Redmond, WA (US); Jeremiah Kemper, SAMMAMISH, WA (US); Charles Bissonnette, REDMOND, WA (US); Unni Ravindranathan, ISSAQUAH, WA (US); Billy Chow, KIRKLAND, WA (US)

(21) Appl. No.: 13/922,245

(22) Filed: Jun. 20, 2013

(51) Int. Cl. G06T 3/00; G06T 11/20

(52) U.S. Cl. CPC G06T 3/00; G06T 11/203
USPC 345/428; 345/443

(57) ABSTRACT

Guides used to illustrate straight lines for positioning graphic objects in an art board are dynamically altered to maintain a designated offset and alignment when used in simulations of displays with different display resolutions. Each guide is associated with an alignment and offset that is used to position the guide in an art board. When the display resolution of the art board changes, each guide is automatically rendered to a position that maintains the alignment and offset associated with each guide.

### BACKGROUND

A developer may use a graphic design application to create art work for a variety of purposes. Often, the graphic design application has a number of tools that enable a developer to design and display a realistic visual representation of the art work. The art work may be a web page, animated storyboard, user interface, interactive menu, presentations, and the like. The graphic design application may include tools providing the capability to draw various types of shapes and objects, to import digital graphics and media files, to generate real-time animation features, and so forth.

The graphic design application may provide the developer with a canvas or art board to create a design. The art board may be a two-dimensional design surface in which the developer creates the art work. The art board may also have a ruler and one or more guides. A ruler displays measurement units usually at the top horizontal and left vertical edges of the art board. A guide is a single straight line that is used as a visual reference to align objects. A guide runs parallel to either the top horizontal ruler or the left vertical ruler. One or more guides may be used to position an object at a precise location on the art board. The guides are created based on the dimensions of the art board. Often, the guides remain fixed when the art work is used in a medium with a fixed resolution, such as print. However, when the art work is to be used in various types of media, the guides are not useful to the developer.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A design tool may utilize one or more guides to visually represent an alignment in an art board. A guide is represented as a straight line that is parallel to one of the axes of the art board. A guide is associated with an alignment and an offset that is used to position the guide in a particular position in the art board. When the display resolution of the art board changes, each guide is automatically rendered to a position that maintains the alignment and offset associated with the guide.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIGS. 1A-1C are diagrams illustrating exemplary art boards having guides positioned in the same relative position for different display resolutions.

FIG. 2 illustrates an exemplary system that dynamically alters the guides in response to a change in the display resolution of an art board.

FIG. 3 is a flow diagram illustrating exemplary actions that may be performed with the guides.

FIGS. 4A-4B are flow diagrams illustrating an exemplary method for dynamically altering guides based on changes to a display resolution.

FIG. 5 is a block diagram illustrating an exemplary computing device used an exemplary operating environment.

FIG. 6 illustrates an exemplary guide editor.

### DETAILED DESCRIPTION

A design tool has the ability to simulate a realistic visual representation of how a composition is going to look at run time. A design tool may display a simulation of a composition with respect to a fixed-sized display where the positions of the guides remain static. However, in the case where different electronic devices use displays with different display resolutions, the design tool needs the capability to simulate the composition (e.g., artwork) onto the different display resolutions while maintaining the same relative position of the guides. The embodiments described herein pertain to a technology that dynamically alters the position of the guides automatically for different display resolutions while maintaining a relative position of the guides in each simulation.

A display resolution refers to the number of pixels in each dimension of a composition that can be rendered onto a display. The display resolution may be expressed in measurement units of pixels per inch which is calculated as the number of pixels in each dimension (e.g., width×height). A developer may wish to have an object positioned precisely at a particular location within a composition regardless of the display resolution. The developer may design the composition using one or more guides that are positioned on an initial art board. The developer may wish to simulate the visual display of the composition onto other display devices having different display resolutions than the initial art board while maintaining the guides at the same relative position in each simulation.

An art board may be implemented as a two-dimensional rectangle that has a top edge and a left edge. One ruler may be positioned at the top edge of the art board (i.e., top horizontal ruler) and another ruler may be positioned at the left edge of the art board (i.e., left vertical ruler). A guide is a single straight line that is used as a visual reference to align objects. A guide may be represented as a vertical line that runs parallel to the left vertical ruler and may be represented as a horizontal line that runs parallel to the top horizontal ruler. A guide is represented in terms of an alignment and an offset. An alignment refers to a direction, such as left, right, top, bottom that is relative to a specific edge of the art board. The offset indicates a position from the edge indicated by the alignment.

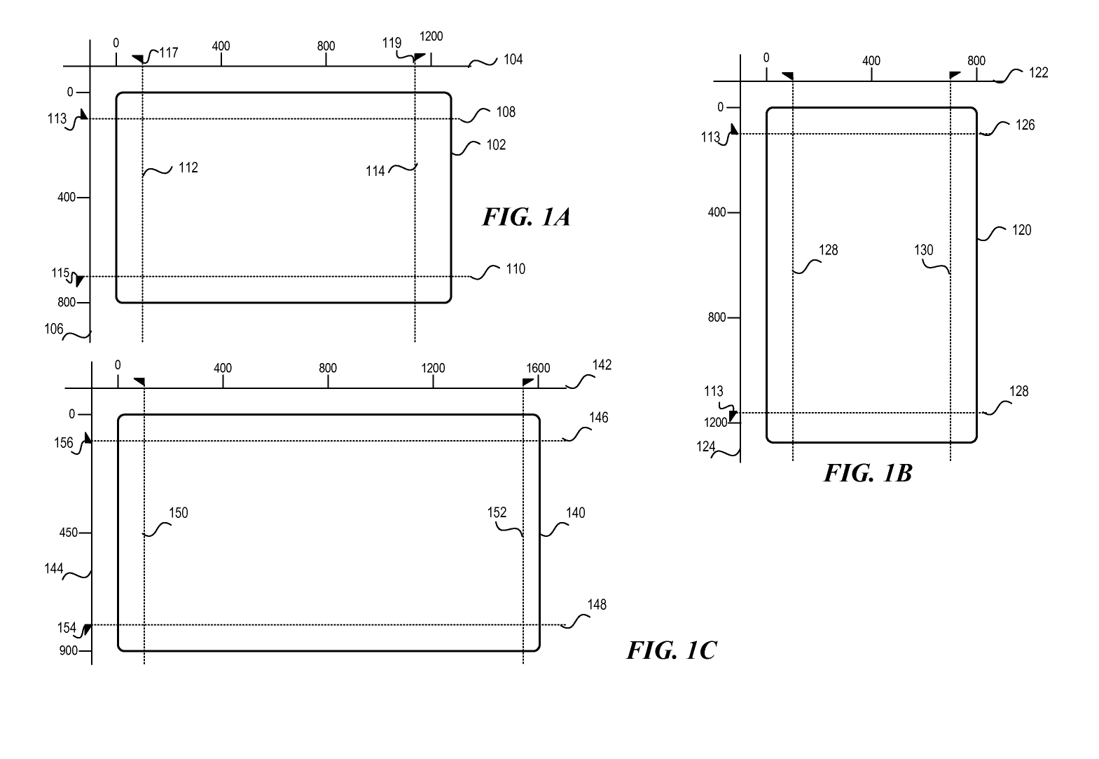

FIGS. 1A-1C illustrate exemplary guides that are used to maintain a 100 pixel margin along each edge of an art board. In FIG. 1A, the guides are positioned in a landscape orientation having a display resolution of 1280×800. FIG. 1B illustrates the location of the guides with the same alignment and offset as shown in FIG. 1A except in a portrait orientation having a display resolution of 800×1280. FIG. 1C illustrates the location of the guides with the same alignment and offset shown in FIGS. 1A-1B except with a display setting having a display resolution of 1600×900.

Referring to FIG. 1A, there is shown an art board 102, having a top horizontal ruler 104, and a left vertical ruler 106. The rulers contain measurement units expressed in pixels. The art board is 1280 pixels wide and 800 pixels long. There are four guides 108, 110, 112, 114. Each guide is associated with an alignment and an offset. A guide is aligned to either one of the rulers in a direction specified by a small triangular flag at one end of a guide.

Guide 108 is a horizontal guide that is aligned to the top horizontal ruler as indicated by the small triangular flag 113 that points in the direction of the top ruler 104 or towards the top edge of the art board. Guide 110 is aligned to the bottom edge of the art board as indicated by the small triangular flag 115 that points towards the bottom of the art board 102. Guide 112 is aligned to the left vertical ruler 106 as indicated by the small triangular flag 117 that points towards to the left edge of the art board. Guide 114 is aligned to the right edge of the art board as indicated by the small triangular flag 119 that points towards the right edge of the art board.

As shown in FIG. 1A, each guide is positioned at an offset from its respective alignment. Guide 108 is positioned 100 pixels from the top horizontal ruler which is at the 100 pixel distance of the left vertical ruler. Guide 110 is positioned 100 pixels from the bottom edge of the art board which is at the 700 pixel distance of the left vertical ruler. Guide 112 is positioned 100 pixels from the left vertical ruler which located at the 100 pixel distance of the top horizontal ruler. Guide 114 is positioned 100 pixels from the right edge of the art board which is at the 1180 pixel distance of the top horizontal ruler.

FIG. 1B shows the guides positioned using the same alignments and offsets shown in FIG. 1A except where the orientation of the art board has changed. The guides maintain a 100 pixel margin along each edge of the art board. In FIG. 1B, the art board 120 is 800 pixels wide and 1280 pixels long. The art board in FIG. 1B is in a portrait orientation. There is a top horizontal ruler 122 and a left vertical ruler 124. Guide 126 is positioned at the 100 pixel distance of the left vertical ruler. Guide 128 is positioned at the 1180 pixel distance of the left vertical ruler. Guide 128 is positioned at the 100 pixel distance of the left vertical ruler and guide 130 is positioned at the 700 pixel distance of the top horizontal ruler.

FIG. 1C shows the guides positioned using the same alignments and offsets shown in FIGS. 1A and 1B to maintain the 100 pixel margin. In FIG. 1C, the dimensions of the art board have changed through user-defined settings. The user-defined settings may be the dimensions of a particular display associated with an electronic device, such as a cell phone, tablet PC, mobile computing device, electronic reader, and so forth. As shown in FIG. 1C, the art board 140 is 1600 pixels wide and 900 pixels long. There is a top horizontal ruler 142 and a left vertical ruler 144. Guide 146 is positioned at the 100 pixel distance of the left vertical ruler 144, guide 148 is positioned at the 800 pixel distance of the left vertical ruler 144, guide 150 is positioned at the 100 pixel distance of the top horizontal ruler 142 and guide 152 is positioned at the 1500 pixel distance of the top horizontal ruler 142.

It should be noted that the guides shown in FIGS. 1A-1C are exemplary and that the guides may take on other configurations. For example, the shape, color, and style of the line used to implement a guide may be of any shape, color and style, such as without limitation, dotted, solid, dashed, or any combination thereof. Each particular style of line maybe used to indicate an attribute of the guide, such as without limitation, whether the line is static, editable, and so forth. In addition, the alignment indicator, which is shown in FIGS. 1A-1C as the small triangular flag, may take on any shape. The embodiments are not limited in this manner.

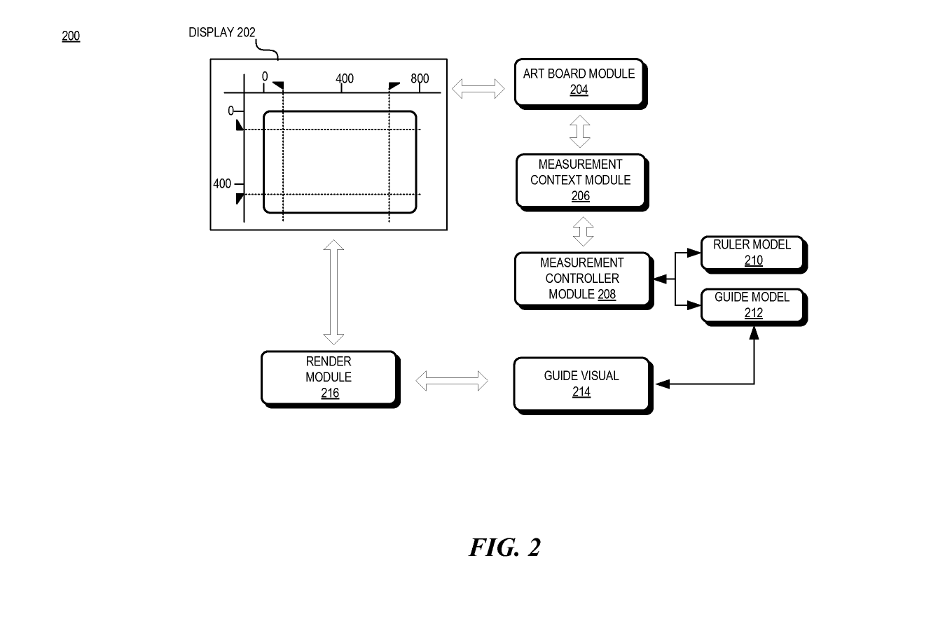

Attention now turns to a discussion of an exemplary system 200 for dynamically altering the guides based on changes to a display resolution. Referring to FIG. 2, the system 200 may include a display 202 showing an art board having rulers and guides. The system 200 may include an art board module 204, a measurement context module 206, a measurement controller module 208, a ruler model 210, a guide model 212, a guide visual 214, and a render module 216. Although the system 200 as shown in FIG. 2 has a limited number of elements in a certain topology, it may be appreciated that the system 200 may include more or less elements in alternate topologies as desired for a given implementation.

The art board module 204 processes input received from the developer through the art board's user interface. The art board module 204 transmits any view changes made by the developer to the measurement context module 206. The measurement context module 206 tracks the current measurement of the various elements that are associated with the view of the art board. Examples of such elements may be the size of the art board, the size of the display device, the alignment, offset, and positions of the guides, the current zoom level, and so forth. When a change in the measurement of one of these elements is detected, the art board notifies the measurement context module 206 of the change. The measurement context module 206 updates the current state of the measurement which is then transmitted to the measurement controller module 208.

The measurement controller 208 interacts with a ruler model 210, a guide model 212 as well as other models associated with elements of the art board. The ruler model 210 tracks the measurements that affect the ruler and generates ruler data that is used to position each component of the ruler on the art board. The guide model 212 tracks the measurements that affect each guide and generates guide data that is used to position each guide on the art board. The measurement controller 208 passes the measurement context data to the guide model 212 which the guide model 212 uses to update the new positions of the guides with respect to the new settings of the art board. A guide view 214 is used to identify the changes needed to the presentation to position the guides in their respective relative positions on the art board. A render module 216 renders the guides in these positions onto the art board and display 202.

In one or more embodiments, the art board module 204, the measurement context module 206, the measurement controller module 208, the guide visual 214, the ruler model 210, the guide model 212, and the render module 216 may be a sequence of computer program instructions, that when executed by a processor, causes the processor to perform methods and/or operations in accordance with a prescribed task. The art board module 204, the measurement context module 206, the measurement controller module 208, the guide visual 214, the ruler model 210, the guide model 212, and the render module 216 may be implemented as program code, programs, procedures, module, code segments, program stacks, middleware, firmware, methods, routines, and so on. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

In one or more embodiments, the art board module 204, the measurement context module 206, the measurement controller module 208, the guide visual 214, the ruler model 210, the guide model 212, and the render module 216 may be part of a graphics software application, an graphic editor, a graphic modeling tool, an interactive development environment (IDE), a stand-alone application, and in any combination of the above.

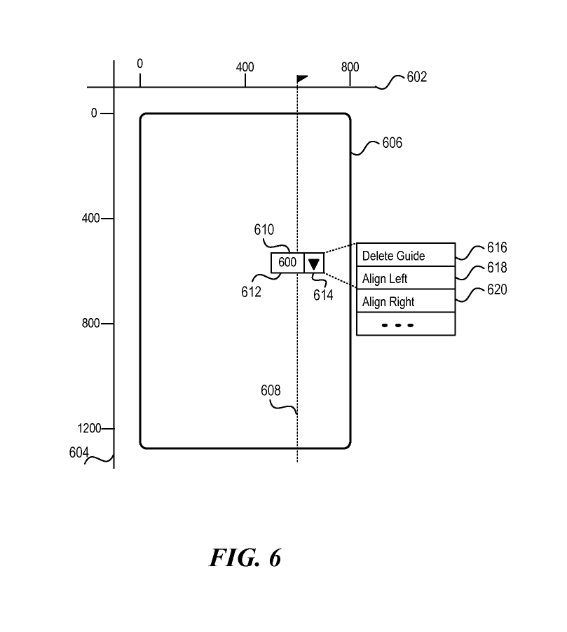

FIG. 6 illustrates an exemplary guide editor. A guide editor allows a user to change the configuration of a guide. As shown in FIG. 6, there is an art board 606 having a top horizontal ruler 602 and a left vertical ruler 604. There is a single guide 608 positioned vertically at the 600 pixel distance from the left vertical ruler 604. In one or more embodiments, the guide editor 610 may appear on the art board when a user selects the guide, either by touching the guide through a touch screen, clicking a mouse over the guide, hovering a mouse or pointing device over a guide, and so forth.

The guide editor 610 may include a position unit 612 and a menu 614. The position unit 612 may display the current position of the guide. The menu 614 may display the various editing functions that may be applied to the guide. For example, the menu 614 may be a drop down menu that displays a function to delete the guide 616, to change the guide's left alignment 618, to change the guide's right alignment 620, and any combination thereof. A user may select one of the functions associated with the menu 614 to alter edit the guide.

However, it should be noted that the illustration of the guide editor is exemplary and that the embodiments are not limited to the configuration shown in FIG. 6. Other functions may be included in the menu 614 and the guide editor 610 may be configured with other shapes, sizes, colors, and so forth.

Attention now turns to a discussion of the various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

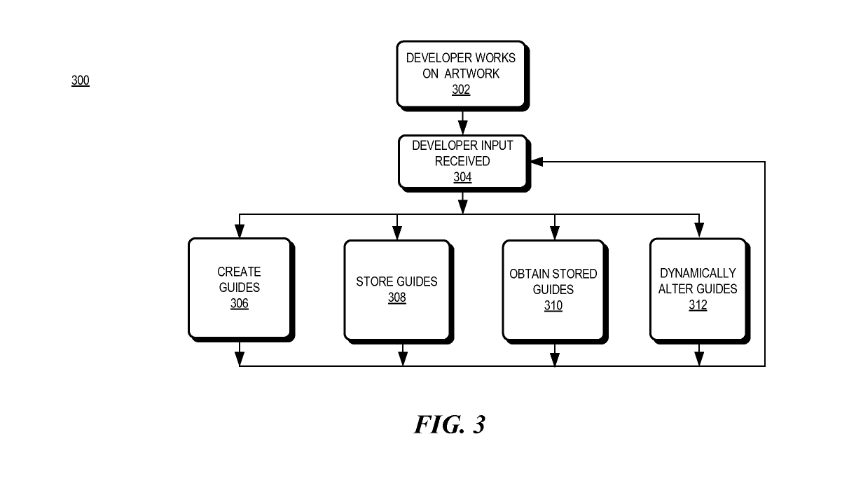

FIG. 3 illustrates a flow diagram of an exemplary method for receiving a developer's input while designing an art work using the art board. It should be noted that the method 300 may be representative of some or all of the operations executed by one or more embodiments described herein and that the method can include more or less operations than that which is described in FIG. 3.

A developer (e.g., user, programmer, end user, etc.) may utilize a graphic design application to design, create, edit, and/or simulate an art work. The graphic design application may be any type of software program that provides the needed capabilities for this purpose. The graphic design application may include tools, menus, user interfaces, etc. that a developer uses to design, create, edit, and/or render a simulation of the art work (block 302). The art board module may receive one or more inputs from the developer (block 304). In particular, the developer may perform one or more actions that affect the guides. For example, a developer may create one or more guides (block 306), store one or more of the guides for later use (block 308), obtain guides that were previously created and stored (block 310), and dynamically alter the positions of the guides when the display resolution of the art board changes (block 312).

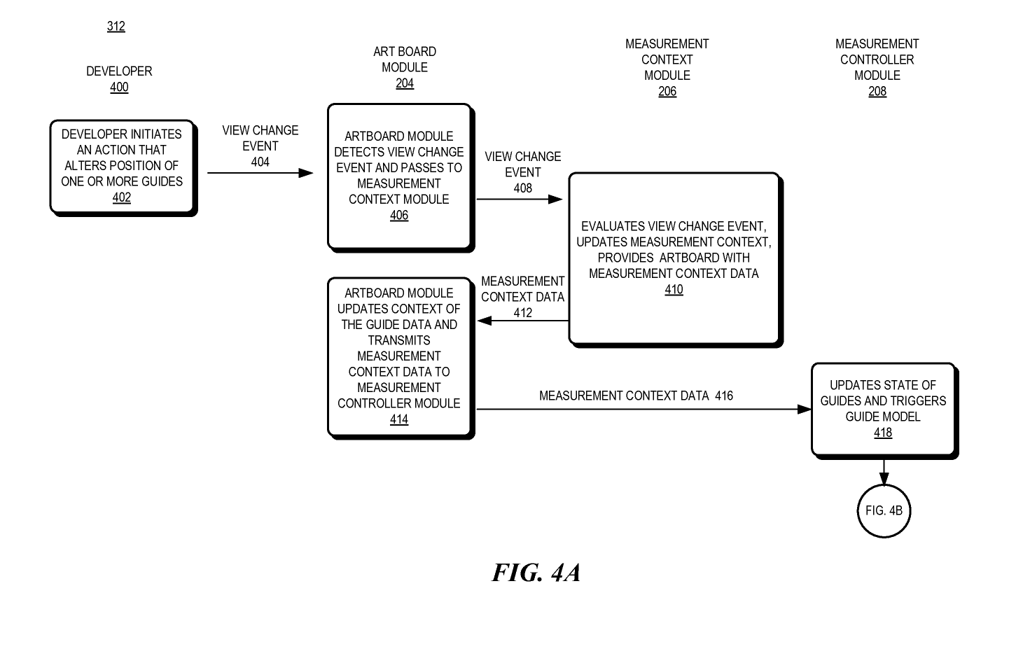

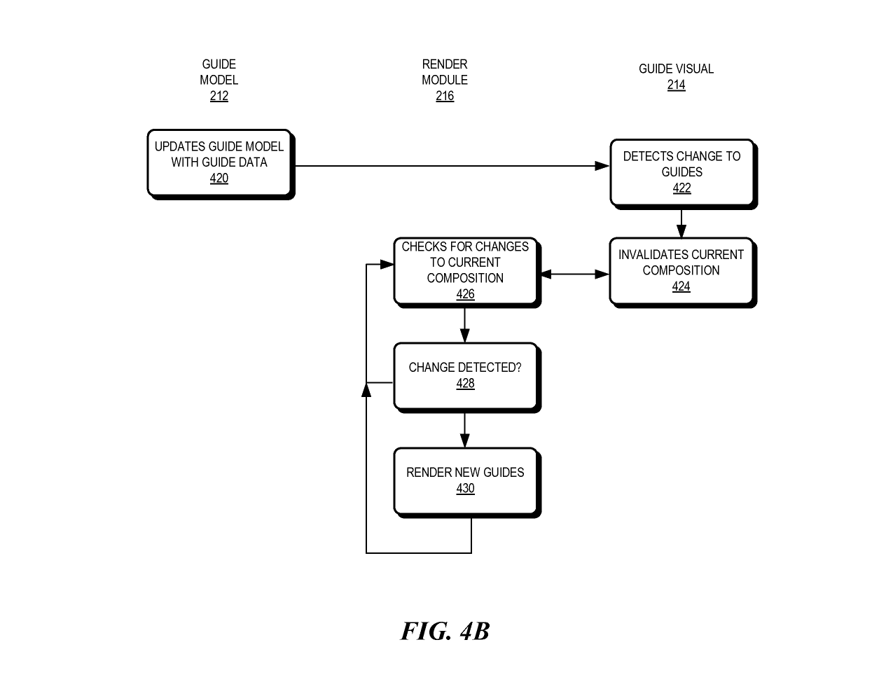

FIGS. 4A and 4B illustrate a flow diagram of a method for dynamically altering the position of the guides when the display resolution of the art board changes. It should be noted that the method 400 may be representative of some or all of the operations executed by one or more embodiments described herein and that the method can include more or less operations than that which is described in FIGS. 4A-4B.

A developer 400 may initiate an action that generates a view change event 404 that is received by the art board module (block 402). The action may be an orientation change, such as a change from portrait mode to landscape mode and vice versa. The action may be a change to the display resolution of the art board caused by the developer altering one or more of the dimension settings of the art board.

The view change event 404 is passed to the measurement context module 206 (block 406). The measurement context module 206 analyzes the event 404 and determines an appropriate course of action that needs to be performed. The measurement context module 206 updates the current state of the guides to reflect the view changes The measurement context module 206 then provides the art board module 204 with the measurement context data 412 (block 410). The art board module 204 instructs the measurement controller module 208 to update the state of the guides (block 410). The measurement context module 206 triggers the guide model 212 to update the current state of the guides (block 418) and control is passed to the guide visual module 214 (block 422).

Referring to FIG. 4B, the guide visual module 214 invalidates the current composition of the art board (block 424). The render module 216 continuously checks for an indication from the guide visual module 214 as to when to render or draw a new composition to the art board (block 426, block 428—no). When a change is detected (block 428—yes), then the render module 216 draws the guides placed in positions that conform to the guide's alignment and offset settings (block 430).

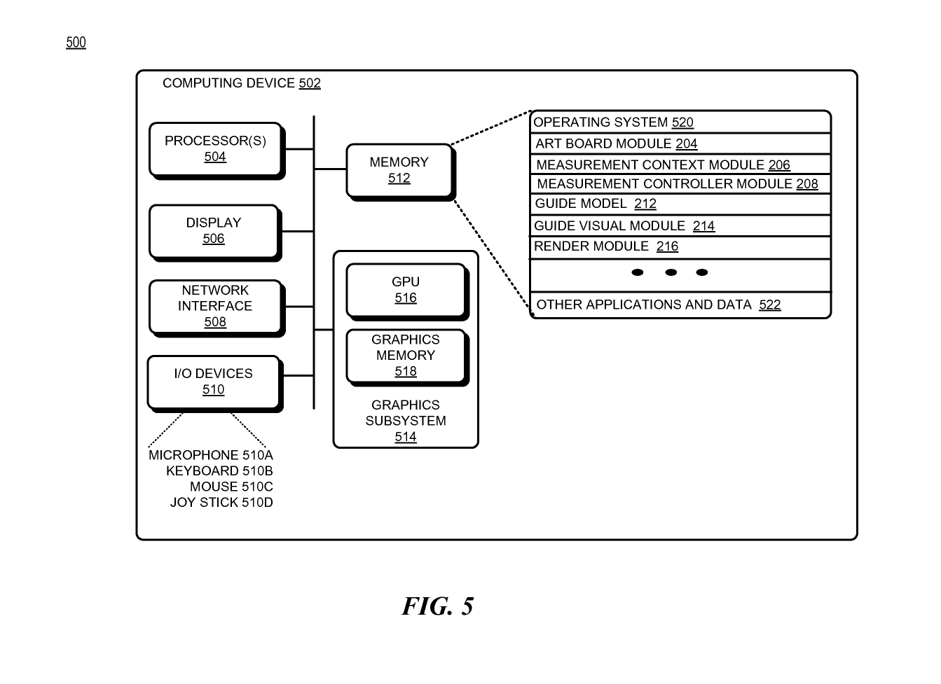

Attention now turns to a discussion of an exemplary operating environment. Referring now to FIG. 5, there is shown a schematic block diagram of an exemplary operating environment 500 including a computing device 502. The computing device 502 may be any type of electronic device, such as, without limitation, a mobile device, a personal digital assistant, a mobile computing device, a tablet, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof.

The computing device 502 may have one or more processors 504, a display 506, a network interface 504, one or more input/output (I/O) devices 510, and a memory 512. The computing device 502 may include a graphics subsystem 514 having a graphics processing unit (GPU) 516 and a graphics memory 518.

A processor 504 may be any commercially available processor and may include dual microprocessors and multi-processor architectures. The network interface 508 facilitates wired or wireless communications between the computing device 502 and a communication framework. The I/O devices 510 may include a microphone 510A, a keyboard 510B, a mouse 510C, a joy stick 510D as well as other devices, such as a pointing device, devices to receive voice input, a touch screen input, devices to accept gesture input, and so forth.

The memory 512 may be any type of computer-readable storage media or computer-readable storage device that stores executable procedures, applications, and data that does not pertain to propagated signals, such as modulated data signals transmitted through a carrier wave. The memory 512 may be implemented as a memory device (e.g., random access memory, read-only memory, etc.), magnetic storage, volatile storage, non-volatile storage, optical storage, DVD, CD, floppy disk drive, flash drive, and any combination thereof. The memory 512 may also include one or more external storage devices or remotely located storage devices. The memory 512 may contain instructions and data as follows:
an operating system 520;
an art board module 204;
a measurement context module 206;
a measurement controller module 208;
a guide model 212;
a guide visual module 214;
a render module 216; and
various other applications and data 522.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, a measurement bar may be used to show the change in the position of a guide when a guide is created or repositioned where the measurements are independent of the guide alignment. The measurement bar (e.g., ruler) may be used to show the distance of the guide to each side of the art board, within the same alignment (e.g, vertical or horizontal) as well as the distance to any other guide positioned in the same alignment on either side of the guide. For instance, if a first vertical guide is positioned 100 pixels from the left edge of the art board and a second vertical guide is dragged from a position of 150 pixels to the left edge of the art board to a position that is 200 pixels from the left edge of the art board, the measurement bar will display values ranging from 50 pixels at the beginning of the drag to 100 pixels at the end of the drag. In this manner, the measurements for the new guide positions may be made faster since they are independent of the alignment.

What is claimed:

1. A computer-implemented method, the method comprising:
associating at least one guide with an alignment and an offset, the alignment indicating a direction relative to an edge of an art board, the offset indicating a distance relative to the alignment;
receiving one or more guides for placement on a first art board, the first art board having a first display resolution;
determining a placement for the guide that maintains the alignment and offset associated with the guide in the first display resolution; and
rendering the guide in the determined placement in the first art board.

2. The computer-implemented method of claim 1, further comprising:
altering the art board to a second resolution;
selecting select ones of the guides that are not positioned within the alignment and offset associated with the guide in the second resolution; and
rendering the select ones of the guides to a position that maintains the offset and alignment associated with each of the select ones of the guides in the second resolution.

3. The computer-implemented method of claim 1, wherein the second resolution is based on an orientation change.

4. The computer-implemented method of claim 1, wherein the second resolution is based on a change to one or more dimensions of the first art board.

5. The computer-implemented method of claim 1, wherein one or more guides have an indicator showing a direction associated with the alignment.

6. The computer-implemented method of claim 1, further comprising:
storing data representing one or more of the guides.

7. The computer-implemented method of claim 1, further comprising:
obtaining data representing the alignment and offset of a guide from a storage location.

8. A computer-readable storage medium storing thereon processor-executable instructions, comprising:
a first set of processor-executable instructions that when executed on a processor, associates a guide with an alignment and an offset, obtains one or more guides, determines a placement for a guide on a first art board having a first resolution, and renders the guides in a position on the first art board that maintains the alignment and offset associated with a guide, the alignment indicating a direction relative to an edge of an art board, the offset indicating a distance relative to the alignment.

9. The computer-readable storage medium of claim 8, further comprising:
a second set of processor-executable instructions that when executed on a processor, alters the first art board to a second resolution, selects ones of the guides that are not positioned within the offset and alignment associated with a guide in the second resolution, and renders a position of the select ones of the guides that maintains the offset and alignment associated with a guide in the second resolution.

10. The computer-readable storage medium of claim 9, wherein the second resolution is based on an orientation change.

11. The computer-readable storage medium of claim 9, wherein the second resolution is based on a change to one or more dimensions of the first art board.

12. The computer-readable storage medium of claim 8, wherein one or more guides have an indicator showing a direction associated with the alignment.

13. The computer-readable storage medium of claim 8, further comprising a third set of processor-executable instructions that stores data representing the alignment and offset of a guide to a storage location.

14. The computer-readable storage medium of claim 8, further comprising a fourth set of processor-executable instructions that obtains data representing the alignment and offset of a guide from a storage location.

15. A computer-implemented system, comprising:
a memory storing one or more guides, a guide associated with an alignment and an offset, the alignment indicating a direction relative to an edge of an art board, the offset indicating a distance relative to the alignment; and
a processor executing programmable instructions that determines a placement for a guide on an art board, and renders one or more guides to a respective position on the art board that maintains the alignment and offset associated with a guide.

16. The computer-implemented system of claim 15, the processor executing further programmable instructions that alters the first art board to a second resolution, selects ones of the guides that are not positioned within the offset and alignment associated with the select guides in the second resolution, and renders a position for the select ones of the guides that maintains the offset and alignment associated with a guide in the second resolution.

17. The computer-implemented system of claim 16, wherein the second resolution is based on an orientation change.

18. The computer-implemented system of claim 16, wherein the second resolution is based on a change to one or more dimensions of the first art board.

19. The computer-implemented system of claim 16, wherein one or more guides have an indicator showing a direction associated with an alignment.

20. The computer-implemented system of claim 16, the processor executing further programmable instructions that obtains data representing an alignment and offset of a guide from a storage location.
